(19) United States
(12) Patent Application Publication
(10) Pub. No.: US 2020/0087985 A1
(43) Pub. Date: Mar. 19, 2020

(54) LADDER SAFETY DEVICE IMPROVEMENTS

(71) Applicant: William D. Polzen, Lake Oswego, OR (US)

(72) Inventor: William D. Polzen, Lake Oswego, OR (US)

(21) Appl. No.: 16/132,770

(22) Filed: Sep. 17, 2018

(51) Int. Cl. E06C 7/42; E06C 7/46; E06C 7/44

(52) U.S. Cl. CPC E06C 7/423; E06C 7/44; E06C 7/46

(57) ABSTRACT

According to principles of the present inventive concepts, various improvements to a ladder safety device are provided. In one embodiment, a simplified attachment mechanism can be provided where an angled leg bracket is aligned with and then permanently affixed to base bracket. The base bracket may include sidewalls to bracket around opposite sides of a ladder leg. An attachment mechanism of the ladder safety device may removably attach to the ladder through rung holes already present in the ladder using alignment tubes, one of which is threaded to receive a bolt. In other embodiments, the attachment mechanism may comprise an inner and outer mount configured to securely sandwich the ladder leg between the mounts. Enlarged foot pads, leg extensions, level mounts, and other accessories may also be provided to further improve the ladder safety device.

### BACKGROUND

### Field of the Inventive Concepts

The present inventive concepts relate generally to ladders and to ladder safety devices for improving ladder stability. More particularly, the present inventive concepts relate to accessories and improvements to the ladder safety device disclosed and described in U.S. Pat. No. 9,482,053 and to other ladder safety devices.

### SUMMARY

According to various embodiments and principles of the present inventive concepts, improvements to previous ladder safety devices can improve both performance and cost effectiveness of the ladder safety device. Various accessories can also improve the usefulness and adaptability of ladder safety devices.

Conventional ladders can be unstable, particularly on uneven ground. The longer the ladder and the further it is extended, the more unstable and dangerous it may become, particularly on uneven ground surfaces. A ladder safety device can be used to increase ladder stability and decrease the risk of ladder accidents. In addition, a method of attachment can be used to secure the ladder safety device (or other ladder accessories) to conventional ladders with little or no modification to the ladder itself.

According to principles of the present inventive concepts, improvements to the construction and operation of a ladder safety device can further improve its operation and cost effectiveness. In addition, other types of ladders may be accommodated by the present inventive concepts, and additional accessories and attachments can further improve ladder safety performance and provide numerous additional benefits, such as improved cost effectiveness and ease of manufacturing.

A ladder safety device may comprise a pair of stabilizing legs attached to a ladder through an attachment mechanism. The attachment mechanism is preferably configured to securely, but removably, attach a stabilizing leg to each side of the ladder. The stabilizing legs are preferably each capable of being independently angled away from the ladder at one or more angular positions. The stabilizing legs are further each preferably provided with length adjustment mechanism to permit a length of each of the legs to be adjusted independently of a length of the other leg. This can facilitate secure placement of the ladder on uneven surfaces.

In the previous embodiment, the attachment mechanism can comprise a pair of alignment tubes configured to be arranged in openings of the rungs in the ladder. A first alignment tube can be placed in the rung opening on one side of the ladder and a second corresponding alignment tube can be placed in the corresponding opening on the opposite side of the ladder. Threaded bolts (or a bar having two threaded ends) can be fed through the attachment mechanism alignment tubes. Nuts can be attached to the bolt ends to secure the attachment mechanism to the ladder. Alignment bars or additional alignment tubes and bolts can be provided to mate within one or more additional rung openings (or other openings in the ladder legs) to help ensure the attachment mechanism and ladder safety device remains appropriately aligned with the ladder. Similar attachment mechanisms could be used to attach other accessories to a ladder.

According to one improvement contemplated herein, a threaded hole can be provided in one or more of the alignment bars or tubes. A threaded bolt can be inserted through an opening in an opposite alignment bar or tube. A self-alignment mechanism can be provided by an end of the bolt (having a tapered, non-threaded end) and a threaded hole (having a tapered opening) in the corresponding alignment bar or tube. The self-alignment mechanism can permit the bolt end to easily align with and feed into the tapered opening of the threaded hole, and the bolt can then be threaded into the hole to secure the safety device to the ladder.

According to a further improvement of the present inventive concepts, each attachment mechanism can comprise a base bracket configured with sidewalls (bracket arms) that extend away from a base to fit around (i.e., on opposing sides) of the ladder legs to bracket the ladder legs. The alignment bars or tubes can extend from an inside wall of the base. Contact surfaces of the base bracket can be provided with a nonslip material to help grip the ladder leg. For example, neoprene or foam rubber strips can be arranged on the inside of the sidewalls. A neoprene or foam rubber insert can also be arranged on the inside wall of the base between the alignment bars or tubes. And additional foam rubber or neoprene strips can be placed along the inside wall of the base at opposite (i.e., top and bottom) ends of the base bracket.

An angled leg mount bracket can be welded or otherwise attached directly to the outer wall of the base of the base bracket. For example, protrusions in the angled leg mount bracket can be configured to fit into slots formed in the base to properly align the angled leg mount bracket with the base. The angled leg mount bracket can then be welded or otherwise attached to the base. This simplified base bracket structure can reduce manufacturing costs and also improve the connection between the ladder safety device and the ladder.

The base bracket can further comprise a mounting hole configured to receive a level mount containing a level. The level mount can be secured in the mounting hole of the base bracket such that the level is mounted at a desired angle. In operation, the level indicator of the level will indicate that the ladder is level when the ladder is leaning at the desired angle from a structure.

According to another aspect of the present inventive concepts, an improvement to the ladder safety device can facilitate attachment to a step, fiberglass, or other ladder, without requiring openings in ladder rungs for attachment. An attachment mechanism can comprise an outer connection member (outer mount) and an inner connection member (inner mount). The outer mount can be configured having sidewalls that bracket or surround front and back sides of the ladder legs. The inner mount can be configured to abut an inner side of the ladder legs and can be connected to the outer mount to sandwich the ladder leg between the inner and outer mounts. The inner and outer mounts may include nonslip (such as neoprene, foam rubber, or other rubberized) contact surfaces or inserts that permit them to securely contact the ladder legs without slipping. The inner and outer mounts can connect together through a connection mechanism. This connection mechanism may, for instance, include bolts that are inserted through matching holes in the inner and outer mounts, and which can be tightly secured using nuts or by fitting into threaded holes on an opposing mount.

The inner mount may comprise one or more connection bars. At least one of the connection bars may be removably inserted into grooves or notches formed in the inner mount. The removable connection bar can facilitate securing the inner mount to a step ladder or other ladder having angled step support bars. The connection bars may provide one or more of the holes for securing the inner mount to the outer mount. The connection bars may be arranged at an angle with respect to a longitudinal axis of the inner mount to avoid interference with steps or other features of the attached ladder.

Feet can be provided on each of the legs of the ladder safety device such that a base of each foot can be angled to best contact a ground surface. The feet can include a nonslip contact surface made from a material, and having a structure and design, that provides a good grip with the ground surface in various weather conditions.

According to improvements of the present inventive concepts, in addition to the variable angle of the feet provided by a swivel attachment to the legs, the feet can further be angled at a fixed, predetermined angle in the direction of ladder lean so that the surface of the feet are positioned substantially flat against the ground surface when the ladder is leaned against the desired structure or when the step ladder is opened.

According to another improvement, a separate, removable, enlarged foot pad may be supplied to provide a more stable footing on sand, mud, dirt, concrete, or other ground surfaces. The larger foot pad can be configured to secure over the existing feet using a removable attachment mechanism. The removable attachment mechanism may comprise a rod or pin configured to slide through matching holes on an attachment structure of the larger foot pad and attachment structures (such as bushings) arranged above the feet. The rod can further comprise an enlarged end that prevents the end of the rod from entering the holes, and a catch bar rotatably attached to the enlarged end that can flip over the opposite end to keep it from sliding out of the holes once inserted. The rod and catch bar can, for instance, be a locking linch pin assembly. The enlarged foot pad can further include one or more holes arranged through a base of the foot pad that permit attachment of the foot pad to the ground surface. Spikes or stakes, for example, can be placed through the base holes to secure the base to sand, dirt, or other soft ground surfaces. Concrete screws, wood screws, nails, or other attachment devices could be placed through the holes to secure the foot pad to concrete, wood, or other hard surfaces.

According to a still further improvement, a leg extension can be provided to enable one or more of the legs to be extended beyond their conventional adjustability. The leg extension can include an enlarged end configured to receive a lower section of the ladder safety device leg, and a smaller end configured to insert into an upper section of the ladder safety device leg. The leg extension can further comprise holes for receiving locking pins to lock the leg extension in place in the upper section of the ladder safety device leg and to lock the lower section of the ladder safety device leg in place in the leg extension.

Various additional aspects, embodiments, and configurations of the inventive concepts are possible without departing from the principles disclosed herein. The inventive concepts are therefore not limited to any of the particular aspects, embodiments, or configurations described herein.

### BRIEF DESCRIPTION OF FIGURES

The foregoing and additional objects, features, and advantages of the present inventive concepts will become more readily apparent from the following detailed description of preferred embodiments, made with reference to the accompanying drawings, in which:

FIG. 1 is a somewhat schematic plan view of the ladder safety device and attachment mechanism according to the prior art;

FIGS. 2A and 2B are somewhat schematic plan and side views, respectively, of a bottom leg segment of the ladder safety device of FIG. 1, according to the prior art;

FIG. 3 is a somewhat schematic view of a top leg segment of the ladder safety device of FIG. 1, according to the prior art;

FIGS. 4A to 4C are somewhat schematic views of an attachment mechanism for attaching a ladder safety device to a ladder according to the prior art;

FIG. 5 is a somewhat schematic illustration of a ladder safety device attached to a ladder and arranged in a storage position, according to the prior art;

FIG. 6 is a somewhat schematic illustration of a ladder safety device attached to a ladder and arranged in a stable support position on level ground according to the prior art;

FIGS. 7A and 7B are somewhat schematic illustrations of a ladder safety device attached to a ladder and arranged in a stable support position on uneven ground according to the prior art;

FIGS. 8A and 8B are somewhat schematic illustrations of additional accessories that may be provided on the attachment mechanism of the ladder safety device according to the prior art;

FIGS. 9A and 9B are somewhat schematic plan and side views of a contact surface for a foot of the ladder safety device according to the prior art;

FIG. 10 is a somewhat schematic front view of an improved ladder safety device and accessories attached to a ladder, illustrating various aspects of the present inventive concepts;

FIGS. 11A-11C are close-up views of a foot assembly of the improved ladder safety device of FIG. 10, illustrating attachment of a large foot pad to the smaller foot pad of the ladder safety device according to one aspect of the present inventive concepts;

FIG. 12 is a close-up cross-sectional view, illustrating attachment of the base bracket of the improved ladder safety device of FIG. 10 to the ladder, according to another aspect of the present inventive concepts;

FIG. 13A-13D are various views of the base and angled leg brackets of the improved ladder safety device of FIG. 10, illustrating a mechanism for aligning the angled leg bracket with the base bracket during manufacture of the ladder safety device according to another aspect of the present inventive concepts;

FIGS. 14A-14D are side, back, top, and perspective views, respectively, of a fully-constructed base for the improved ladder safety device of FIG. 10;

FIG. 15A is an enlarged view of Detail A of FIG. 14B, and FIGS. 15B-15C are side and front views of a threaded alignment rod or tube, illustrating improvements for receiving and securing the connecting bolt according to principles of the present inventive concepts;

FIGS. 16A-16D are various views of an opposite base of the ladder safety device of FIG. 10, for connecting to the base of FIGS. 14A-14C;

FIG. 17 is a somewhat schematic side view of a bolt for connecting the opposing bases together;

FIG. 18 is a somewhat schematic shaded perspective view of a threaded alignment rod or tube providing a threaded connecting boss for receiving a bolt with a self-alignment mechanism for connecting opposing bases together;

FIGS. 19A-19C are various views of a level mount and level for attaching to the base of FIGS. 16A-16D;

FIGS. 20A and 20B are somewhat schematic perspective and side views of a foot for the ladder safety device of FIG. 10, and FIGS. 20C and 20D are somewhat schematic perspective and side views of a foot for the ladder safety device according to other embodiments of the present inventive concepts;

FIGS. 21A and 21B are somewhat schematic perspective and side views of an enlarged foot pad for attachment to the ladder safety device of FIG. 10;

FIG. 22 is a somewhat schematic perspective view of a linch pin assembly for connecting the enlarged foot pad of FIGS. 20A and 20B to the foot of FIGS. 19A-19C of the ladder safety device of FIG. 10;

FIGS. 23A-23B provide somewhat schematic perspective and front views of an improved ladder safety device attached to a step ladder according to still further principles of the present inventive concepts;

FIG. 24 is a somewhat schematic shaded illustration of a connection between the leg and foot of the improved ladder safety device of FIG. 23A;

FIGS. 25A and 25B provide somewhat schematic side and perspective views of a connected outer mount and inner mount of the improved ladder safety device of FIG. 23A according to a still further aspect of the present inventive concepts;

FIGS. 26A and 26B are perspective views of the outer mount and inner mount, respectively, illustrating additional features of the present inventive concepts; and

FIGS. 27A and 27B are perspective views of the outer and inner mounts, respectively, shown disconnected from each other, further illustrating additional features of the present inventive concepts.

### DETAILED DESCRIPTION OF ILLUSTRATIVE EMBODIMENTS

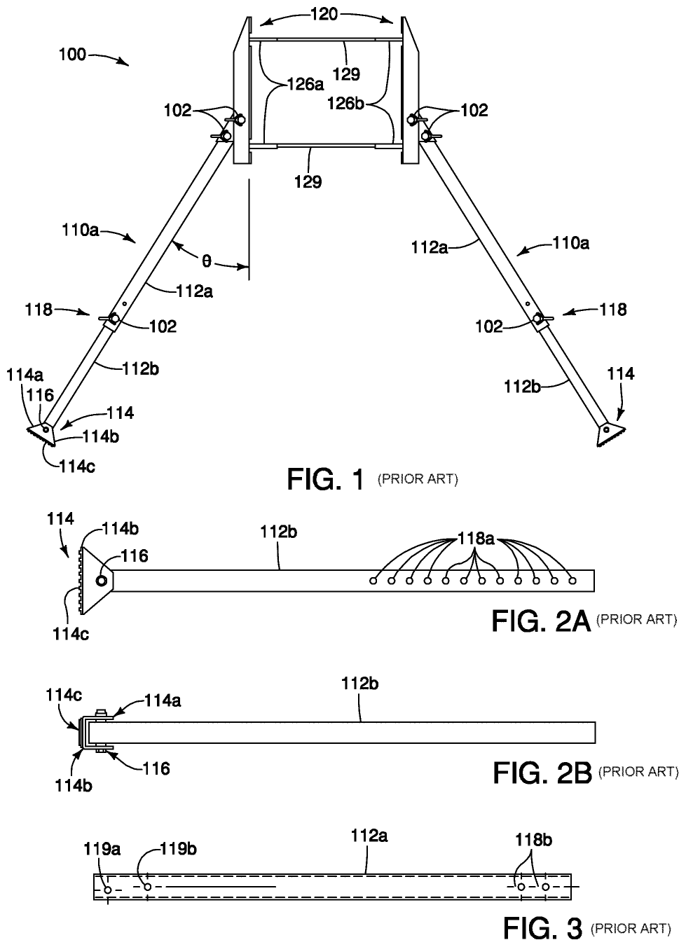

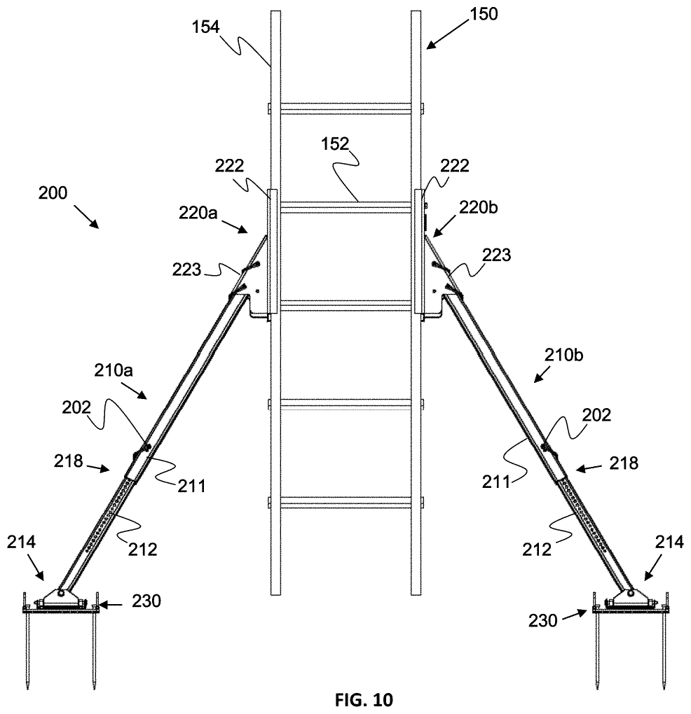

Various features, benefits, and configurations incorporating principles of the present inventive concepts in illustrative embodiments are shown in the accompanying drawings. Additional features, benefits and configurations will be readily apparent to those of ordinary skill in the art based on this disclosure, and all such features, benefits and configurations are considered to be within the scope of the present inventive concepts. Various illustrative embodiments will now be described in connection with the accompanying drawings. Initially, the prior art ladder safety device will be described in detail with reference to FIGS. 1-9B. Various improvements to, and accessories for, the ladder safety device and other inventive concepts will then be described with reference to FIGS. 10-27B.

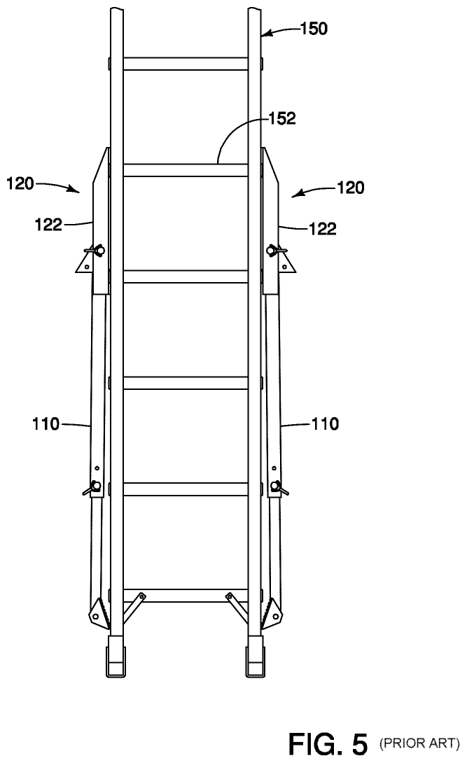

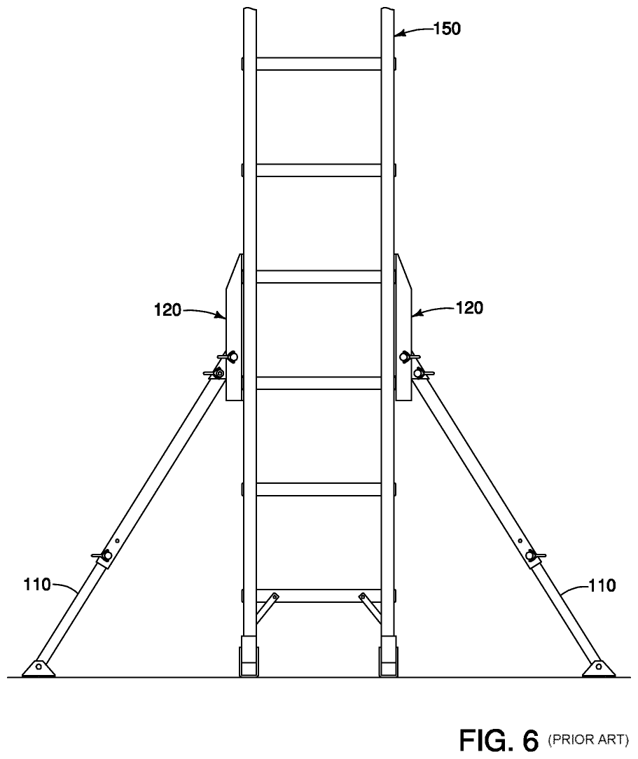

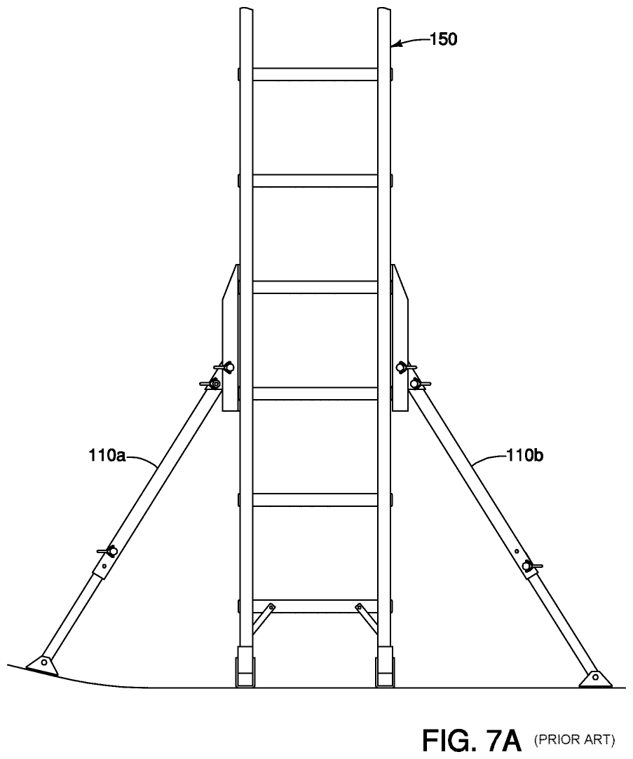

FIG. 1 is a somewhat schematic plan view of a ladder safety device 100 constructed according to the prior art. Referring to FIG. 1, a ladder safety device 100 preferably comprises a pair of stabilizing legs 110a, 110b that can be attached to a ladder through an attachment mechanism 120. The attachment mechanism 120 can be configured to securely, but removably, attach a stabilizing leg 110 to one or both sides of the ladder 150 (see FIGS. 5 and 6). The stabilizing legs 110 can be attached such that they are capable of being angled at one or more angular positions θ with respect to the ladder 150.

Anchor pins 102 can be provided through mating holes in the legs 110a, 110b and the attachment mechanism 120 to secure the legs 110a, 110b to the attachment mechanism 120. The anchor pins 102 can also selectively fix the relationship (or angle) between the legs 110a, 110b and the attachment mechanism 120, and thereby provide the desired angular position θ with respect to the ladder 150.

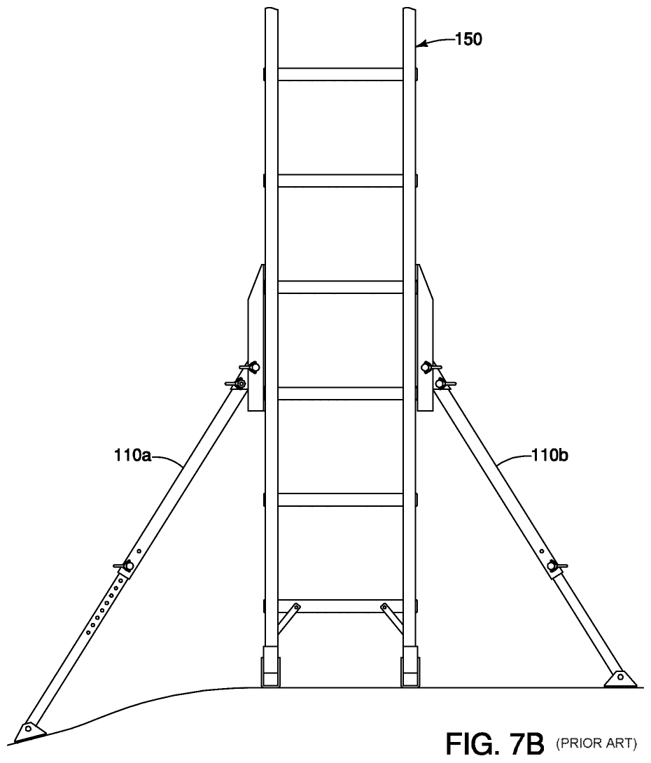

The stabilizing legs 110a, 110b are further each preferably provided with length adjustment mechanisms 118 to permit a length of each of the legs 110a, 110b to be adjusted independently of a length of the other leg 110b, 110a, respectively. The length adjustment mechanism 118 can, for instance, include a tube-in-tube leg design, wherein a bottom leg segment 112b is slidably arranged within a top leg segment 112a (or vice versa). An anchor pin 102 can be inserted through mating holes in the leg segments 112a, 112b to lock the leg in the desired length. This can facilitate secure placement of the ladder 150 on uneven ground surfaces (see FIGS. 7A and 7B).

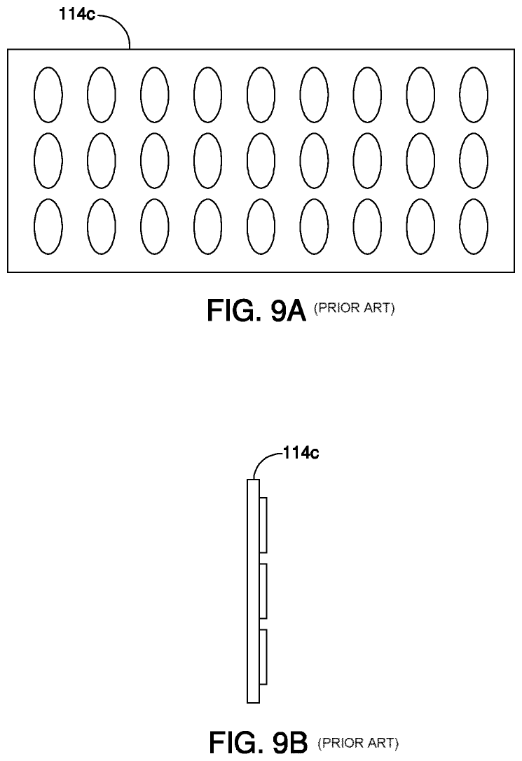

Feet 114 can be provided on each of the legs 110a, 110b such that a base 114b of each foot can be angled to best contact a ground surface. For instance, the feet 114 can be attached with a single bolt or pin 116 arranged through a sidewall 114a extending upward from the base 114b of the foot such that it provides a pivot point for enabling the foot base 114b to rotate with respect to the leg 110a. The feet 114 can include a contact surface 114c on the bottom of each foot base 114b made from a material (e.g., rubber, slip-resistant plastic, etc.) and/or having a structure and design (e.g., contoured rubber, metal, or plastic plate or spikes, etc.) that provides a good grip with the ground surface in various weather conditions (see, e.g., FIGS. 9A and 9B).

FIGS. 2A and 2B are somewhat schematic plan and side views of a bottom leg segment 112b of a leg 110 of the ladder safety device of FIG. 1. FIG. 3 is a somewhat schematic plan view of a top leg segment 112a of the ladder safety device 100 of FIG. 1. Referring now to FIGS. 2A through 3, the structure and operation of the stabilizing legs 110a, 110b will now be described in further detail.

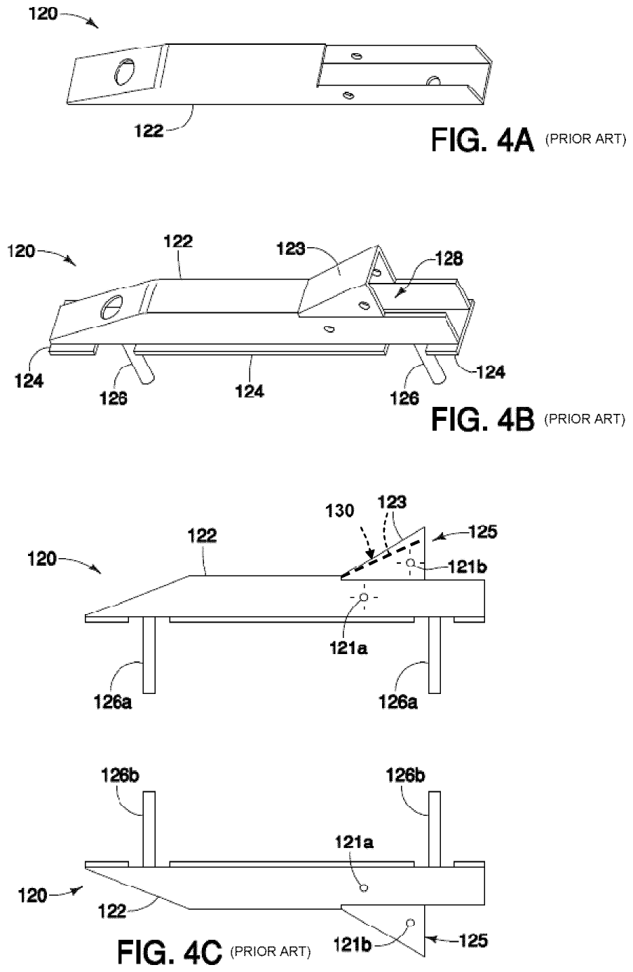

As explained previously with respect to FIG. 1, each of the stabilizing legs 110a, 110b can be provided with an adjustment mechanism 118 that facilitates adjustment of a length of the leg. In an adjustment mechanism 118 having a tube-in-tube design, the bottom leg segment 112b can be configured to slidably mate inside an internal tube of the top leg segment 112a (or vice versa). The bottom leg segment 112b or top leg segment 112a can be configured with a plurality of holes 118a and the other mating leg segment 112a or 112b can also be provided with one or more holes 118b. An anchor pin 102 (see FIG. 1) can be selectively arranged through mating holes 118a, 118b in the leg segments 112a, 112b to secure the leg in a desired length. Additional holes 119 can be provided in the top leg segment 112a, to mate with corresponding holes 121 in the attachment mechanism 120 (see FIG. 4C).

FIGS. 4A through 4C provide various somewhat schematic illustrations of an attachment mechanism 120 for attaching the ladder safety device 100 of FIG. 1 to a ladder. Referring additionally to FIGS. 4A through 4C, the attachment mechanism 120 can include a main body 122. The main body 122 can have a plurality of base plates 124 welded thereto to abut against an attached ladder 150 (see, e.g., FIG. 5). One or more alignment tubes 126 can also be secured to the attachment mechanism 120 (for instance by welding), and can be configured to be arranged in openings of the rungs in the ladder 150. Mirroring attachment mechanisms 120 can be provided on opposite sides of the ladder 150.

More specifically, one alignment tube 126a can be placed in a rung opening on one side of the ladder 150 and a corresponding alignment tube 126b can be placed in a corresponding rung opening on the opposite side of the ladder. Threaded bolts (or a bar having two threaded ends) 128 can be fed through the attachment mechanism alignment tubes 126a, 126b. Nuts (not shown) can be attached to ends of the bolt 128 to secure the attachment mechanism 120 to the ladder. Alignment bars or pegs (not shown), or additional alignment tubes 126 and bolts 128 can be provided to mate within one or more additional rung openings (or other openings in the ladder legs) to help ensure the attachment mechanism and ladder safety device remains appropriately aligned with the ladder 150.

FIGS. 5 and 6 are somewhat schematic illustrations of a ladder safety device 100 attached to a ladder 150 in a storage and a deployed relationship, respectively. Referring additionally to FIGS. 5 and 6, a method of attaching a ladder safety device 100 to a ladder 150 will now be described in further detail. Of course, it should be noted that these steps can be provided in any desired order and the method is not limited to the specific order disclosed herein.

First, the ladder 150 is deployed (extended to a desired length). One or more attachment mechanisms 120 can then be used to secure the legs 110 to the ladder 150. A base attachment 122 is the first part of the assembly to be attached and secured to the ladder 150. The base attachment 122 of the ladder safety device can include right and left side base structures 122 along with alignment tubes 126 to facilitate an easy attachment.

To begin assembly, the right and left side base structures 122 are aligned with their respective sides of the ladder 150. Alignment tubes 126 are used to line up the base attachment 122 with the openings (not shown) of the desired rung(s) 152 on the ladder 150 on both the left and right sides. For instance, alignment tubes 126 arranged near the top of both left and right side base attachments 122 can be put into openings in the fourth rung up from the bottom of the ladder 150.

To secure the base attachments 122 to the ladder 150, two threaded bolts (or a rod having two threaded ends) 129 can be fed through the base attachment alignment tubes 126. Once fed through left and right base attachment alignment tubes 126, a nut (not shown) can be attached and secured on each of the threaded bolt or rod ends. Once the nuts are tightened securely against inside walls of the base attachments 122, the rest of the ladder safety device 100 can be attached.

Stabilizing legs 110 are preferably inserted into a receptacle 128 arranged at the bottom of each of the secured base attachments 122. The stabilizing legs 110 are preferably sized and shaped to have a good fit with the inside of the receptacles 128. Once fitted inside the base attachment receptacles 128, a through top hole 121a in each base attachment 122 preferably lines up with a through hole 119a in a corresponding one of the stabilizing legs 110. Once the holes are aligned, a locking pin 102 can be inserted to securely attach the stabilizing leg 110 to the respective base attachment 122.

Each stabilizing leg 110 can then be pulled out at an angle θ where it meets flush with an alignment wall 123 of the base attachment 122. The alignment wall 123 can, for instance, be an outer wall of the receptacle 128, or a wall 123 of an alignment insert 130 corresponding to a different desired angle. The alignment wall 123 can be configured to line up the stabilizing legs at a desired angle θ to provide stability to the ladder 150. Alternatively, the entire receptacles 128 themselves can be arranged at the desired angle θ from the base attachments 122.

The sidewalls of the receptacles 128 can be part of a protrusion 125 from the base attachment 122. In this configuration, receptacle through holes 121b can be arranged through the protrusions 125 on the base attachments 122 to line up with second through holes 119b on the stabilizing legs. Locking pins 102 can be inserted through the receptacle through holes 121b and second through holes 119b to lock the stabilizing legs 110 in their extended position away from the base of the ladder 150.

Each of the legs 110 can be provided with a telescoping feature that allows them to be adjusted to a desire length. For instance, each leg can comprise an inner leg structure 112b and an outer leg structure 112a. A receiving hole (not shown) in the outer leg structure 112a can allow the inner leg structure 112b to slide within the outer leg structure 112a to provide a variable length for the overall leg structure 110. A plurality of length setting through holes 118a can be arranged on each inner leg structure 112b, with one or more leg length locking through holes 118b arranged on the outer leg structure 118a. With each leg 110 set at a desired length, locking pins 102 can be inserted through the leg length locking through hole 118b and a desired one of the leg length setting through holes 118a on each leg 110 to lock the length of each of the stabilizing legs 110 at its desired length.

FIGS. 7A and 7B illustrate use of the ladder safety device 100 on uneven ground conditions. Referring now additionally to FIGS. 7A and 7B, each of the legs 110 can be extended to a desired length to contact a ground surface and stabilize the ladder 150. For instance, a length of the first leg 110a can be set either shorter (FIG. 7A) or longer (FIG. 7B) than the length of the second leg 110b to accommodate ladder placement along an uphill or downhill slope, respectively. The feet 114 on the stabilizing legs 110 can further rotate to match an angle of the ground surface, and contact surfaces 114b on the feet can help ensure good traction to prevent the legs 110 from slipping.

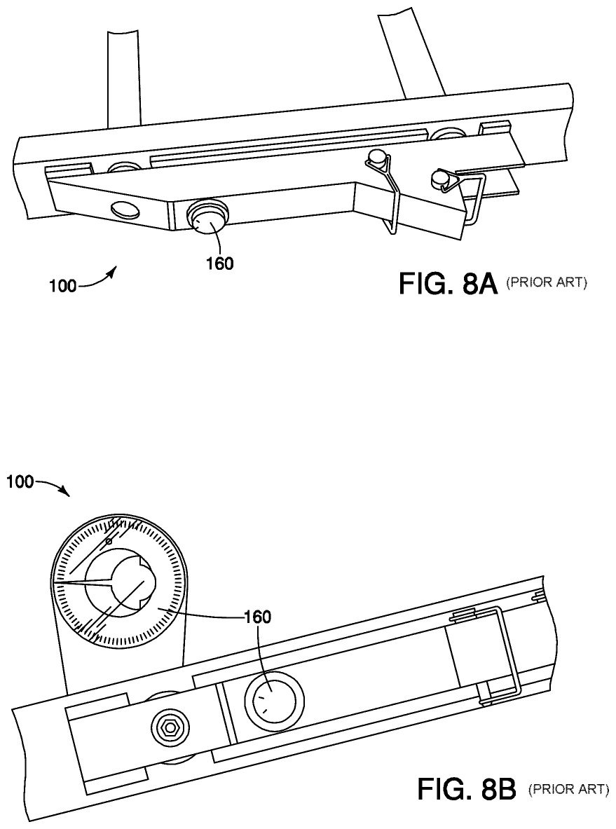

FIGS. 8A and 8B are somewhat schematic illustrations providing examples of further accessories that can be provided to the ladder safety device 100. Referring now to FIGS. 8A and 8B, the ladder safety device 100 can further include one or more gauges 160 indicating a level of inclination of the ladder 150 to facilitate a quick determination of whether the ladder is inclined at a potentially dangerous angle. Other accessories could also be provided to the ladder safety device to promote safe ladder usage. Other configurations of the ladder safety device are also contemplated.

For instance, although various mechanical structures are shown for attaching the base attachments to the ladder, other methods of attaching the base attachments to the ladder are also contemplated. Separate bolt holes could be drilled or formed in the ladder legs, for instance, with bolts used to secure the base attachments to the legs through the holes. The base attachment of the ladder safety device could alternatively be welded to or formed integrally with the ladder legs such that it forms a permanent part of the ladder. In addition, any number of rung alignment pins or through bars could be included to provide additional stability, and the base attachments could be any desired length to facilitate additional rung alignment pins or bars.

In addition, although various preferred mechanisms for adjusting the length and extension angles of the stabilizing legs, and for locking these positions in place, have been disclosed and described, various other methods for adjusting these features and securing them could also be provided. For instance, the inner leg structures could be provided with depressible pins that are spring-biased toward a protruding position. Depressing the pins could permit movement from one position of the inner leg structures to a different position, thereby facilitating leg length adjustment.

Furthermore, the stabilizing legs could be enabled to be deployed at different angles away from the ladder legs by using an attachment mechanism that permits the stabilizing legs to be deployed at any one of multiple desired angles. Various through holes could be provided, for instance, to permit the stabilizing legs to be deployed at multiple different angles from the ladder legs. The stabilizing legs can be further configured to fold up against the ladder legs to facilitate transportation and storage with the ladder safety device attached to the ladder. Other mechanical structures such as ratcheting mechanisms, gears, or other devices could also be used to permit the legs to extend from the ladder at a desired angle and be securely locked into place.

According to principles of the present inventive concepts, improvements to the construction and operation of a ladder safety device can further improve its operation and cost effectiveness. In addition, other types of ladders may be accommodated by the present inventive concepts, and additional accessories and attachments can further improve ladder safety performance and provide numerous additional benefits. Specific improvements and accessories to the ladder safety device according to principles of the present inventive concepts will now be described in greater detail with reference to FIGS. 10-27B.

Initially, FIG. 10 is a somewhat schematic front view of an improved ladder safety device 200 and accessories shown attached to a ladder 150 according to various aspects of the present inventive concepts.

Referring first to FIG. 10, as with the prior art embodiment, the ladder safety device can comprise a pair of stabilizing legs 210a, 210b attached to a ladder 150 through a pair of attachment mechanism 220a, 220b. The attachment mechanisms 220a, 220b are configured to securely, but removably, attach a stabilizing leg 210a, 210b, respectively, to each side of the ladder 150. The stabilizing legs 210a, 210b are each capable of being independently angled away from the ladder and locked into place. The stabilizing legs 210a, 210b are further each provided with length adjustment mechanisms 218 to permit a length of each of the legs 210a, 210b to be adjusted independently of a length of the other leg. This can facilitate secure placement of the ladder 150 on uneven surfaces.

Unlike the prior art embodiment, however, the ladder safety device of the present inventive concepts can contain numerous improvements to its design and construction that can improve both usability and ease of manufacture. For instance, unlike the prior art embodiment, the attachment mechanisms 220a, 220b of the present embodiment can comprise a more efficient structure. The attachment mechanisms (or “bases”) 220a, 220b can include both a base bracket 222 and an angled leg mount bracket 223. In addition, improvements to the foot assembly 214 and other structures can be provided.

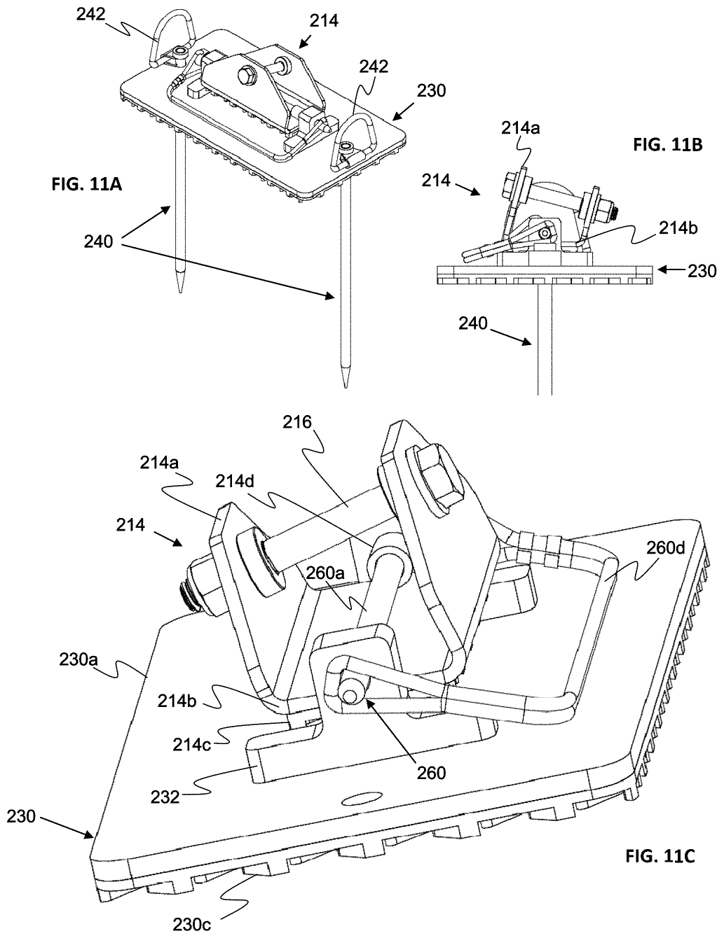

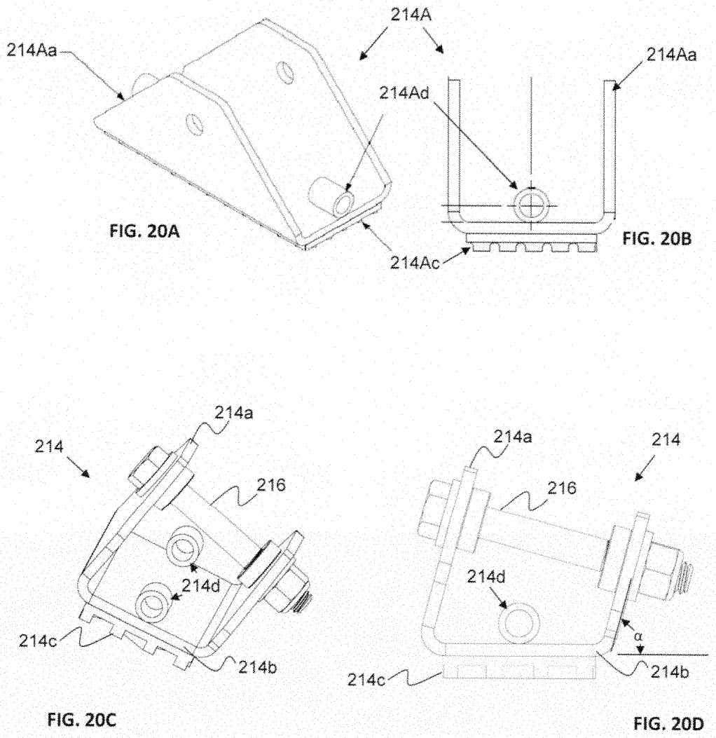

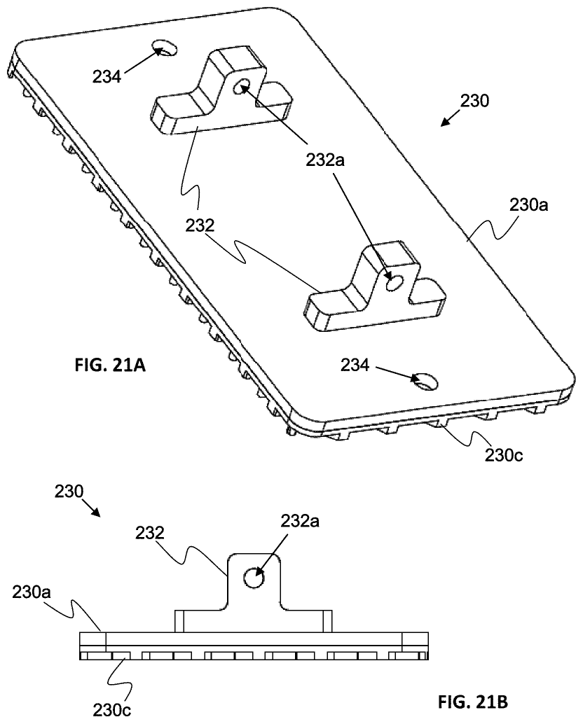

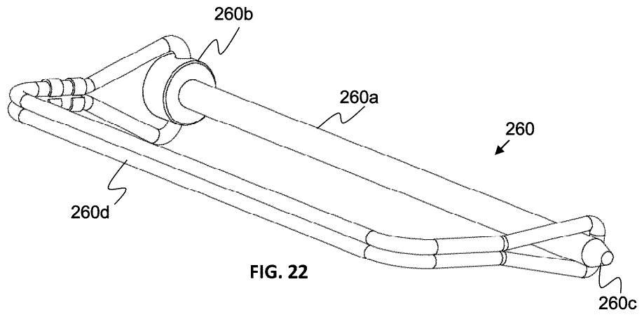

FIGS. 11A-11C are close-up views of a foot assembly 214 of the improved ladder safety device 200 of FIG. 10, further illustrating attachment of a large foot pad 230 to the smaller foot pad assembly 214 of the ladder safety device 200 according to one aspect of the present inventive concepts. FIGS. 20A and 20B are somewhat schematic perspective and side views of one possible foot assembly 214A, and FIGS. 20C and 20D are somewhat schematic perspective and side views of a preferred foot assembly 214 for the ladder safety device 200. FIGS. 21A-21B are somewhat schematic perspective and side views of an enlarged foot pad 230 for attachment to a foot assembly 214 of the ladder safety device 200. And FIG. 22 is a somewhat schematic perspective view of a linch pin assembly 260 used for connecting the enlarged foot pad 230 to the foot assembly 214 of the ladder safety device 200.

Referring to FIGS. 10-11, and 20A-22, feet can be provided on each of the legs such that a base of each foot can be angled to best contact a ground surface. The feet can include a contact surface made from a nonslip material, and having a structure and design, that provides a good grip with the ground surface in various weather conditions.

According to improvements of the present inventive concepts, in addition to the variable angle of the feet provided by a swivel attachment to the legs through the bolt 216, the foot assemblies 214 can further be angled at a fixed, predetermined angle α in the direction of ladder lean so that the surface of the feet are positioned substantially flat against the ground surface when the ladder is leaned against a desired structure. According to further improvements, a separate, removable, larger foot pad 230 may be supplied to provide a more stable footing on sand, mud, dirt, concrete, or other ground surfaces. The larger foot pad 230 can be configured to secure over the existing feet 214 using a removable attachment mechanism.

More specifically, a foot assembly 214, 214A can include a foot bracket 214a, 214Aa having a base 214b, 214Ab and a contact surface 214c, 214Ac. Unlike the prior art and the foot bracket 214Aa of the embodiment shown in FIGS. 20A-20B, the foot bracket 214a can be angled to accommodate a more complete contact with a ground surface when the ladder is leaned at the desired angle. The foot bracket 214a can be connected to the bottom end of the leg 210a, 210b, through a bolt 216. The bolt 216 permits the foot assembly 214 to swivel to maintain good ground contact regardless of the angle of extension of the leg 210a, 210b.

As further illustrated in FIGS. 21A-22, an optional larger foot pad 230 may be provided and attached to the smaller foot assembly 214 to provide a larger contact surface area with the ground surface. The larger foot pad 230 may be connected to the foot assembly 214 through a removable attachment mechanism. The removable attachment mechanism may, for example, comprise a rod or pin 260a configured to slide through matching holes 232a on an attachment structure 232 of the larger foot pad 230 and attachment structures (such as bushings) 214d arranged above and attached to the base 214b of feet 214. The rod 260a can further comprise an enlarged end 260b that prevents the end of the rod 260a from entering the holes 232a, and a catch bar 260d rotatably attached to the enlarged end 260b that can flip over the opposite end 260c to keep it from sliding out of the holes 232a once inserted. The rod 260a and catch bar 260d can provide a locking linch pin assembly 260.

More specifically, the connection structure may include a pair of bushings 214d welded or otherwise secured to the base 214b of the angled bracket 214a, and a pair of mounting arms 232 extending upwards from the base 230a of the larger foot pad 230. A locking linch pin assembly 260 may extend through the bushings 214d of the foot assembly 214 and holes 232a in the arms 232 of the larger foot pad 230 to secure the larger foot pad 230 to the smaller foot assembly 214. A contact surface 230c may be provided on the bottom of the base 230a to provide a larger secure contact with a ground surface.

The larger foot pad 230 can further include one or more holes 234 arranged through the base 230a of the foot pad 230 that permit secure attachment of the foot pad 230 to a ground surface. Spikes or stakes 240 can be placed through the base holes 234 to secure the base 230a to sand, dirt, or other soft ground surfaces. The spikes 240 can include rings 242 to permit them to be more easily pulled free from the ground surface. Concrete screws, wood screws, nails, or other attachment devices (not shown) can be placed through the holes 234 to secure the foot pad 230 to concrete, wood, or other hard surfaces.

A leg extension (not shown) may also be provided for the ladder safety device 200 of FIG. 10. More particularly, a leg extension can be provided to enable one or more of the legs 210, 210A to be extended beyond their conventional adjustability. The leg extension can include an enlarged end configured to receive a lower section 212 of the ladder safety device leg 210, and a smaller end configured to insert into an upper section 211 of the ladder safety device leg 210. The leg extension can further comprise holes for receiving locking pins 202 to lock the leg extension in place in the upper section 211 of the ladder safety device leg 210 and to lock the lower section 212 of the ladder safety device leg 210 in place in the leg extension.

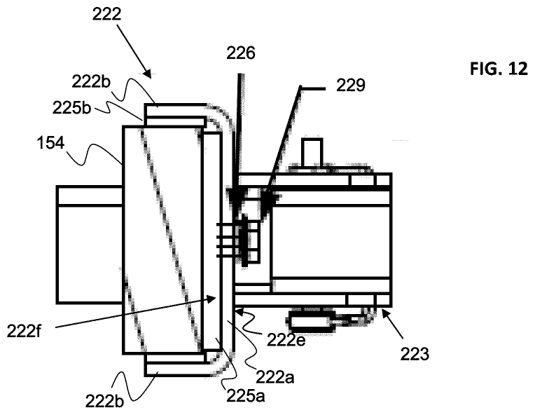

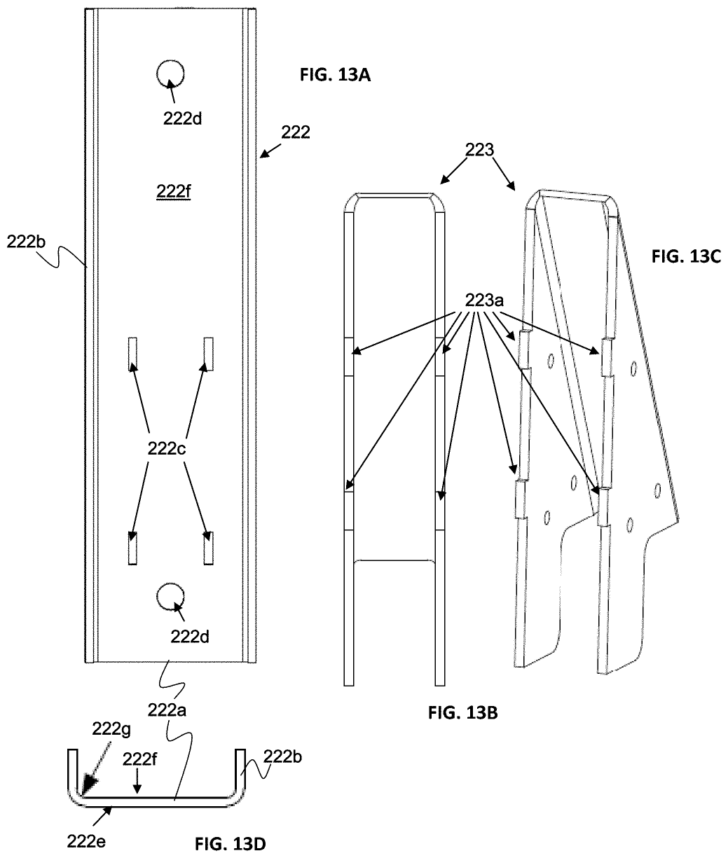

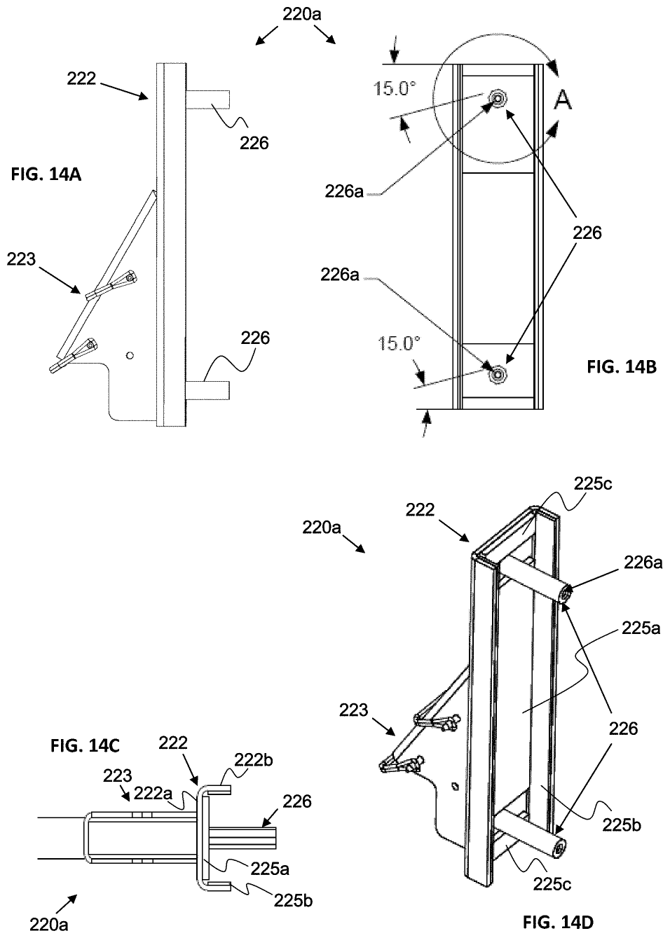

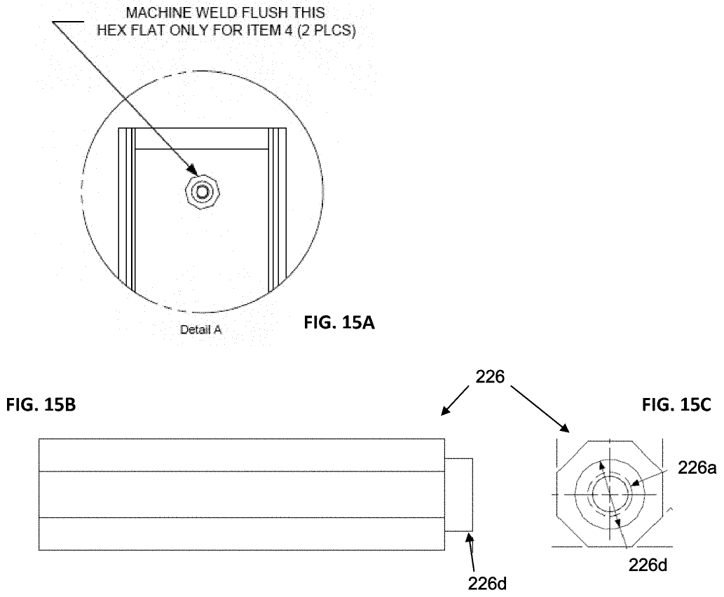

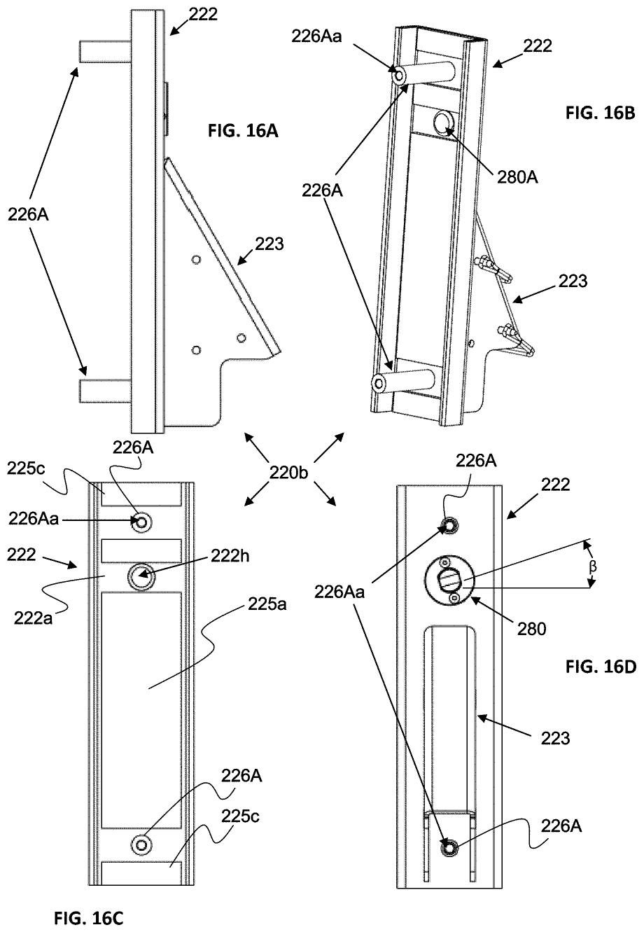

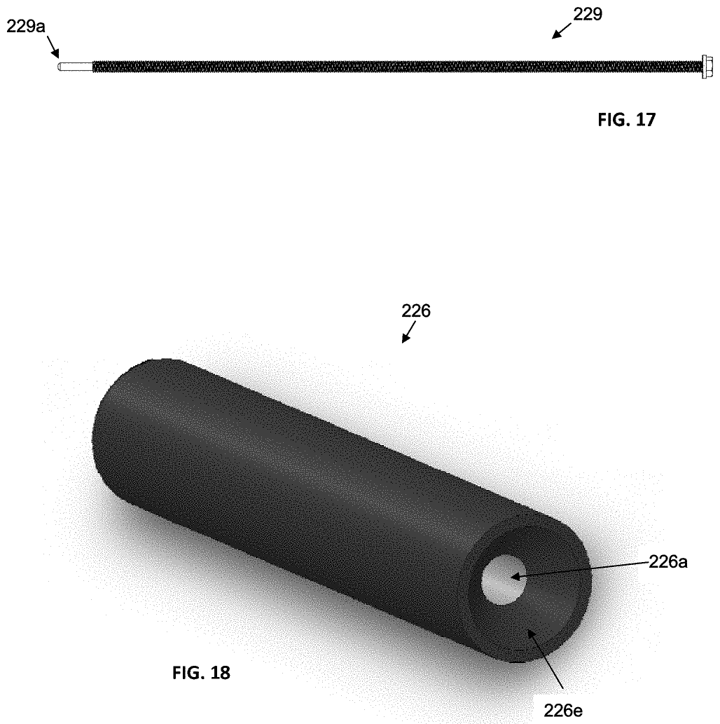

FIG. 12 is a close-up cross-sectional view illustrating attachment of the base bracket 222 of the ladder safety device 200 to the ladder 150. FIGS. 13A-13D are various views of the base and angled leg brackets 222, 223, respectively, of the ladder safety device 200 of FIG. 10, illustrating a mechanism for aligning the angled leg bracket 223 with the base bracket 222 during manufacture of the ladder safety device 200. FIGS. 14A-14D are various views of a fully-constructed base 220a for the ladder safety device 200 of FIG. 10, and FIGS. 16A-16D are various views of an opposite base 220b of the ladder safety device 200 of FIG. 10, for connecting to the base 220a of FIGS. 14A-14D. FIGS. 15A-15C provide various views of the threaded alignment rod 226 attached to the base 220 of FIGS. 14A-14D for receiving the connecting bolt 229 of FIG. 17. And FIG. 18 is a somewhat schematic shaded perspective view of the threaded alignment rod or tube 226 further illustrating a self-alignment mechanism 226e for receiving the self-alignment end 229a of bolt 229.

Referring to FIGS. 12-18, the base 220a, 220b can comprise a simple structure that facilitates ease of manufacture. An angled leg mount bracket 223 can be welded or otherwise attached directly to the outer wall 222e of the base 222a of the base bracket 222. For example, protrusions or tabs 223a on the angled leg mount bracket 223 can be configured to fit into alignment slots 222c formed in the base 222a of base bracket 222 to align the angled leg mount bracket 223 with the base bracket 222. The angled leg mount bracket 223 can then be welded or otherwise attached to the outer wall 222e of the base bracket base 222a. The base bracket 222 can further include alignment holes 222d for receiving the alignment bars or tubes 226. An end 226c of the alignment tubes 226 can be inserted into the alignment holes 222d and secured to the bracket base 222a. This simplified base structure can reduce manufacturing costs and also improve the connection between the ladder safety device 200 and the ladder 150.

According to further improvements of the present inventive concepts, each base bracket 222 can be configured with sidewalls (bracket arms) 222b that extend away from the base 222a to more securely bracket the ladder legs 154 by surrounding opposing sides (i.e., front and back sides) of the ladder legs 154. The sidewalls 222b may be formed by bending outer portions of the base 222a to form rounded corners 222g between the base 222a and sidewalls 222b. The alignment bars or tubes 226 can extend from an inside wall 222f of the base 222a. Contact surfaces 225 of the base bracket 222 (including, for example, the inside wall 222f of the base 222a, and inside surfaces of the sidewalls 222b) can be provided with a nonslip material to help grip the ladder leg 152. For example, neoprene or foam rubber contact points or strips 225b can be arranged on the inside of the sidewalls 222b. A neoprene or foam rubber insert 225a can also be arranged on the inside wall 222f of the base 222a between the alignment bars or tubes 226. Additional foam rubber or neoprene strips or contact points 225c can be placed along the inside wall 222f of the base 222a at opposite (i.e., top and bottom) ends of the base bracket 222.

As explained above, each attachment mechanism can include a base 220, 220A having a pair of alignment tubes or bars 226 configured to be arranged in openings of the rungs 152 in the ladder 150. A first alignment tube 226 can be placed in the rung opening on one side of the ladder and a second corresponding alignment tube 226A can be placed in the corresponding opening on the opposite side of the ladder 150. Unlike the prior art embodiment, where threaded bolts are secured to nuts, in this embodiment, a threaded hole 226a is preferably provided directly in the alignment tubes 226 of one of the bases 220a to receive the threaded bolts 229.

Specifically referring to FIGS. 14A-18, a threaded hole 226a can be provided in one or more of the alignment bars or tubes 226. The threaded bolt 229 can be inserted through a non-threaded opening 226Aa in an opposite alignment bar or tube 226A. A self-alignment mechanism 229a can be provided on an end of the bolt 229 to align the bolt 229 as it is inserted into the threaded hole 226a on the alignment bar or tube 226. More specifically, the self-alignment mechanism 229a can be a tapered, non-threaded end 229a of the bolt 229 that feeds into the threaded hole 226a. In addition, a self-alignment mechanism 226e on the alignment tube 226 can include a tapered or concave entrance to the threaded hole 226a that helps guide the end 229a of bolt 229 into the threaded hole 226a. Once the self-alignment mechanisms 229a, 226e have aligned the bolt 229 with the hole 226a, a threaded portion of the bolt 229 can then be threaded into the hole 226a to secure the opposing bases 220, 220A of the safety device 200 to the ladder 150.

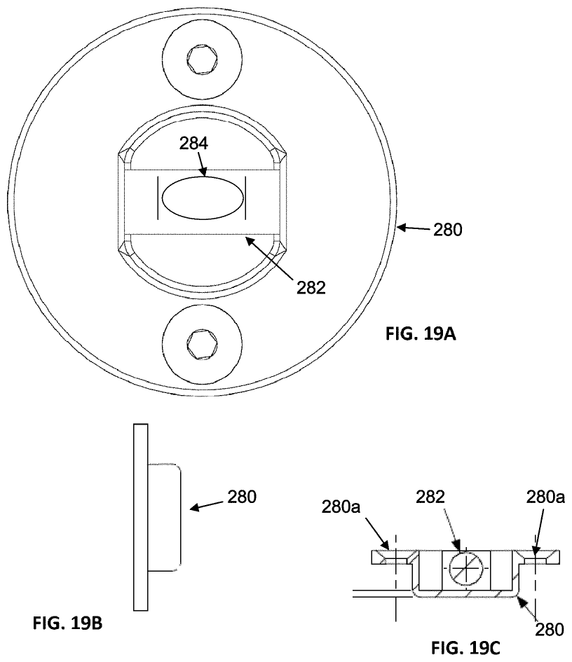

FIGS. 19A-19C are various views of a level mount 280 and level 282 for attaching to the base 220A of FIGS. 16A-16D according to still further principles of the present inventive concepts. As illustrated in FIGS. 16D and 19A-19C, the base bracket 222 can further comprise a mounting hole 222h arranged through the base 222a and configured to receive a level mount 280 containing a level 282. The level mount 280 can be secured in the mounting hole 222h of the base bracket 222 such that the level 282 is mounted at a desired angle β. In operation, the level indicator 284 of the level 282 will indicate that the ladder 150 is level when the ladder 150 is leaning at a desired angle from a structure. Holes 280a may be provided in the level mount 280 to receive screws that connect the level mount 280 to a base 280A arranged on an opposite side of the bracket base 222a.

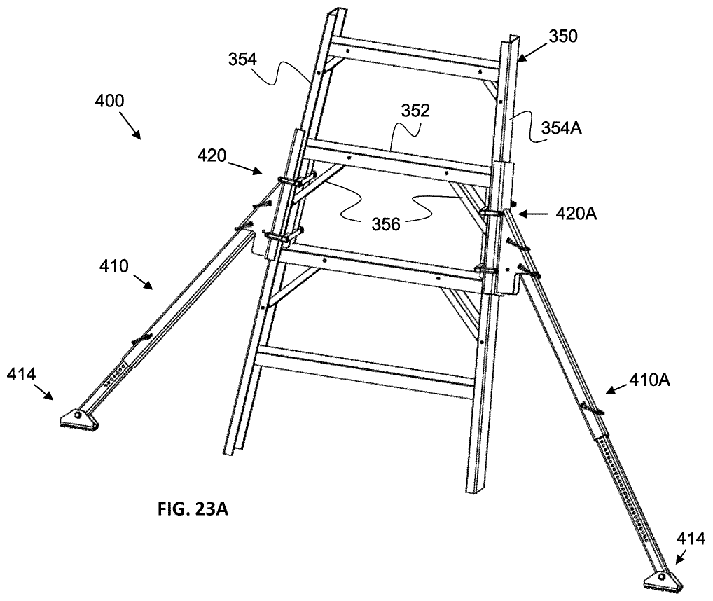

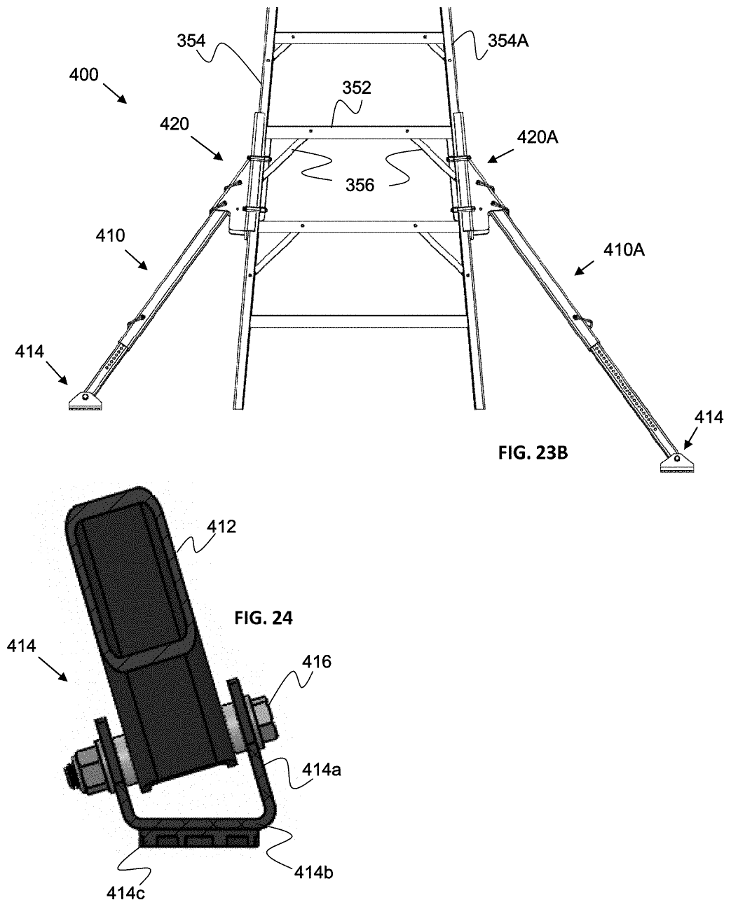

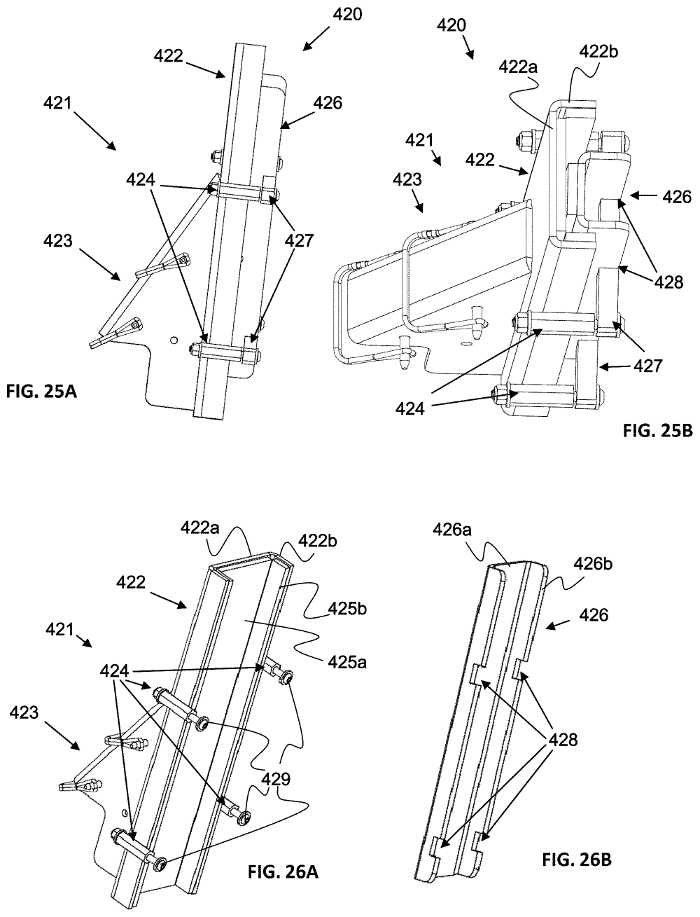

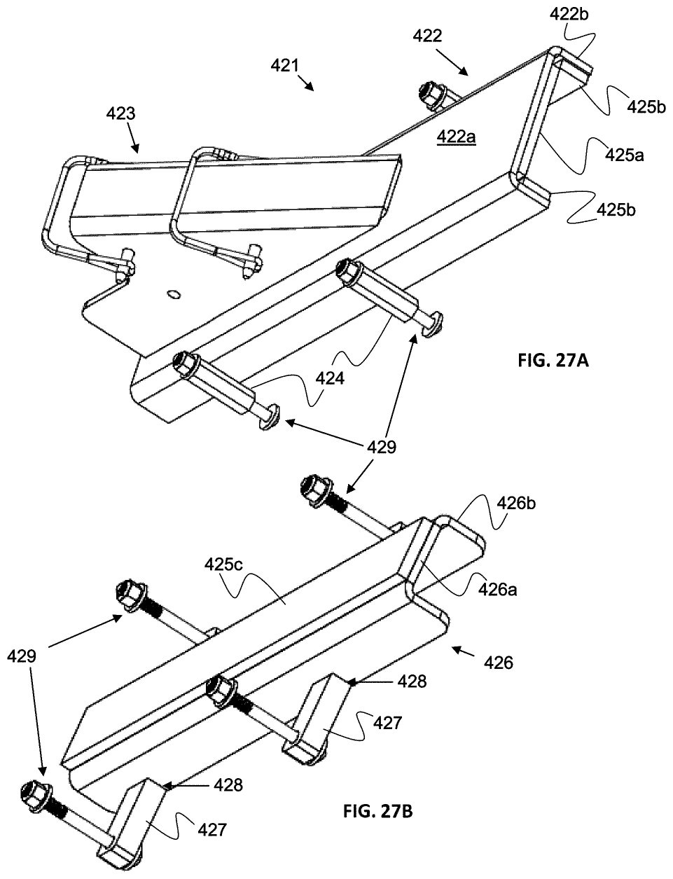

FIGS. 23A-23B provide somewhat schematic perspective and front views of an improved ladder safety device 400 attached to a step ladder 350 according to still further principles of the present inventive concepts. FIG. 24 illustrates a connection between the leg 210 and foot assembly 214 of the improved ladder safety device 400 of FIG. 23A. FIGS. 25A and 25B provide somewhat schematic side and perspective views of a base 420 of the improved ladder safety device 400 of FIG. 23A according to a still further aspect of the present inventive concepts. FIGS. 26A and 26B are perspective views of the outer mount 421 and inner bracket 426, respectively, of the base 420, illustrating additional features of the present inventive concepts. And FIGS. 27A and 27B are perspective views of the outer and inner mounts, 421, 426, respectively, shown disconnected from each other, further illustrating additional features of the present inventive concepts.

Referring now to FIGS. 23A-27B, according to another aspect of the present inventive concepts, an improved ladder safety device 400 can facilitate attachment to a step, fiberglass, or other ladder 350, without requiring openings in the ladder rungs 352. An attachment mechanism (or base) 420, 420A can comprise an outer connection member (outer mount) 421 and an inner connection member (inner mount) 421. The base 420, 420A can receive and attach to support legs 410, 410A, respectively. The outer mount 421 can be configured having sidewalls 422b that bracket or surround front and back sides of the respective ladder leg 354, 354A. The inner mount 426 can be configured to abut an inner side of the ladder leg 354 and can be connected to the outer mount 421 to sandwich the ladder leg 354 between the inner and outer mounts 426, 421, respectively. The inner and outer mounts 421, 426, respectively, may include nonslip (such as neoprene, foam rubber, or otherwise rubberized) contact surfaces or inserts 425a, 425b, 425c that permit them to securely contact the ladder leg 354 without slipping.

The inner and outer mounts 421, 426, respectively, can connect together through a connection mechanism 424. This connection mechanism 424 may, for instance, include bolts 429 that are inserted through matching holes in the inner and outer mounts, 421, 426, respectively, and which can be tightly secured using nuts or by fitting into threaded holes on an opposing mount. In the embodiment shown, a connection member 424 is welded or otherwise attached to the outer mount 421. Bolts 429 are inserted through holes in the connection members 424 in the outer mount 421 and corresponding holes in connection bars 427 of the inner mount 426. Nuts are then secured onto the bolts 429 to secure the mounts 421, 426 together.

As illustrated, the inner mount 426 may comprise one or more connection bars 427. At least one of the connection bars 427 may be removably inserted into grooves or notches 428 formed in the inner mount 426. The other one or more of the connection bars 427 may be permanently affixed to the inner mount 426, or it may also be removably secured in a groove or notch 428. The removable connection bar 427 can facilitate securing the inner mount 426 to a step ladder or other ladder 350 having angled step support bars 356 that would otherwise interfere with the placement of the inner mount 426. As explained above, the connection bars 427 may provide one or more of the holes for securing the inner mount 426 to the outer mount 421. The connection bars 427 may further be arranged at an angle with respect to a longitudinal axis of the inner mount 426 to avoid interference with steps 352 or other features of the attached ladder 350.

Having described and illustrated principles of the present inventive concepts in various preferred embodiments thereof, it should be apparent that the inventive concepts can be modified in arrangement and detail without departing from such principles. Accordingly, the present inventive concepts should not be construed as being limited to the preferred embodiments disclosed herein, but should encompass all such modifications and variations falling within the spirit and scope of the inventive concepts as defined by the following claims.

What is claimed is:

1. A ladder safety device comprising:
a pair of stabilizing legs, each configured to be attached to respective legs of a ladder through an attachment mechanism, such that the stabilizing legs are configured to extend away from the ladder leg at one or more angles to stabilize the ladder when the one or more stabilizing legs are arranged in a deployed position; and
wherein each attachment mechanism comprises a base bracket and an angled leg bracket,
wherein the base bracket is configured to bracket around sides of the ladder leg, and wherein the angled leg bracket is configured to receive the corresponding stabilizing leg.

2. The ladder safety device of claim 1, wherein each attachment mechanism further comprises:
one or more alignment tubes configured to be inserted into rungs of a ladder, and wherein at least one of the alignment tubes comprises a threaded hole for receiving a bolt.

3. The ladder safety device of claim 1, wherein each attachment mechanism comprises:
an inner mount and an outer mount configured to sandwich the ladder leg between them.

4. The ladder safety device of claim 3, wherein the outer mount comprises the base bracket and the angled leg bracket and is configured to abut against an outside of the ladder leg, and wherein the inner mount is configured to abut against an inside of the ladder leg and connect to the outer mount through a connection mechanism.

5. The ladder safety device of claim 4, wherein the connection mechanism comprises at least one connection bar arranged on the inner mount, said connection bar having one or more holes configured to align with one or more holes on the outer mount such that a bolt can be secured through corresponding holes in the inner and outer mount to connect the inner and outer mounts together.

6. The ladder safety device of claim 5, wherein the connection bar is a removable connection bar configured to be removably arranged within grooves or notches formed in the inner mount.

7. The ladder safety device of claim 6, wherein a second connection bar is rigidly attached to the inner mount.

8. The ladder safety device of claim 1, further comprising a leg extension configured to be removably inserted between sections of the stabilizing leg to further extend a length of the stabilizing leg.

9. The ladder safety device of claim 1, further comprising a level mount configured to be inserted into a mounting hole formed in one of the base brackets.

10. The ladder safety device of claim 1, further comprising feet arranged on the stabilizing legs, each foot arranged at a predetermined angle that is less than ninety degrees to match a desired angle of lean of the ladder such that the feet are arranged substantially flat against a ground surface when the attached ladder is leaned at the desired angle of lean.

11. The ladder safety device of claim 1, further comprising a removable foot pad configured to be attached to a stabilizing leg of the ladder safety device to provide a more secure contact with a ground surface.

12. The ladder safety device of claim 11, wherein the removable foot pad is an enlarged foot pad configured to be removably attached below a foot of the ladder safety device.

13. The ladder safety device of claim 11, wherein the removable foot pad is secured to the ladder safety device by inserting a pin or rod through matching holes on the removable foot pad and stabilizing leg.

14. An attachment mechanism for attaching a ladder safety device or other ladder accessory to a ladder, said attachment mechanism comprising:
an outer mount and an inner mount configured to sandwich a ladder leg between the mounts; and
one or more connection mechanisms configured to secure the outer mount to the inner mount along an outside of the ladder leg.

15. The attachment mechanism of claim 14, wherein the inner mount comprises one or more connection bars arranged at a non-perpendicular angle with respect to a longitudinal axis of the inner mount.

16. The attachment mechanism of claim 15, wherein at least one connection bar is removably attachable to the inner mount.

17. The attachment mechanism of claim 16, wherein the removable connection bar is configured to mount within notches or grooves formed in the inner mount.

18. A ladder safety device, comprising:
a pair of attachment mechanisms configured to be arranged on and attached to opposite sides of a ladder, each attachment mechanism comprising:
a base bracket configured to surround at least three sides of a ladder leg; and
an angled leg bracket securely connected to the base bracket; and
a pair of stabilizing legs, each stabilizing leg configured to be received within a corresponding angled leg bracket of the attachment mechanisms.

19. The ladder safety device of claim 18, wherein each base bracket comprises a plurality of alignment slots configured to receive corresponding protrusions from the angled leg bracket, and wherein the angled leg bracket is welded or otherwise secured to the base bracket.

20. The ladder safety device of claim 18, further comprising:
a nonslip surface arranged on the inside of the base bracket to provide a nonslip contact between the base bracket and the ladder leg.
